(19) United States
(12) Patent Application Publication
(10) Pub. No.: US 2010/0093930 A1
(43) Pub. Date: Apr. 15, 2010

(54) Polymer Composition and Process

(76) Inventors: Jong-Shing Guo, Longmeadow, MA (US); Augustin Chen, Cheshire, CT (US); Sheng Jiang, Chicopee, MA (US); Leo Ternorutsky, Longmeadow, MA (US); Keltoum Ouzineb, Drogenbos (BE)

Correspondence Address: CYTEC INDUSTRIES INC., 1937 WEST MAIN STREET, P.O. BOX 60, STAMFORD, CT, 06904-0060, US

(21) Appl. No.: 12/522,564

(22) PCT Filed: Jan. 11, 2008
(86) PCT No.: PCT/EP2008/000199

§ 371 Date: Sep. 30, 2009

Related U.S. Application Data
(60) Provisional application No. 60/880,051, filed on Jan. 12, 2007.

(51) Int. Cl. C08F 2/22

(52) U.S. Cl. 524/832; 524/839

(57) ABSTRACT

There is described a multi step mini-emulsion process for preparing a hybrid acrylic/polyurethane pressure sensitive adhesive (PSA) of very high shear strength, good peel strength and/or also high moisture vapor transmission rate, the process comprising the steps of: a) forming a first aqueous mixture comprising a hydrophilic stabilizer; b) forming separately a second oil mixture comprising: i) at least one vinyl functional polyurethane (optionally prepared from an isocyanate functional monomer; at least one monol and/or at least one α,β-ethylenically unsaturated monomer ii) optionally at least one hydrocarbon polymer (such as polystyrene); and iii) at least one α,β-ethylenically unsaturated monomer (such as (meth)acrylate or acids thereof; and/or iv) option-=ally at least one hydrophobic stabilizer; where components (ii), (iii) and/or (iv) may optionally be the same; c) mixing the aqueous and oil mixtures together to form a pre-(macro) emulsion; d) generating a stable mini-emulsion there-from optionally by applying high shear to form an aqueous continuous phase and stabilized oil droplets of average diameter from about 10 to about 1000 nm, and e) polymerizing the polymer precursor(s) within the droplets, optionally in the presence of a free radical initiator; to obtain a polymer latex.

The present invention relates to the field of pressure sensitive adhesives (PSA) comprising hybrids of polyurethanes and acrylic polymers and/or hybrid mini-emulsion PSAs.

In an attempt to obtain improved properties (for example a better balance between peel and shear) it is desirable to combine different polymers (for example polyurethanes) with the conventional polymers (for example acrylics) used in waterborne adhesives. However, incompatibility between certain polymers often causes the phase separation and the loss of adhesive properties. It is one object of the invention to provide improved hybrid polyurethane/acrylic polymers. It is a separate object of the invention to provide an improved mini-emulsion process to prepare such hybrid polyurethane/acrylic polymers.

Polyols are widely used in polyurethane synthesis, for example to prepare polyurethane dispersions and urethane acrylates. However the use of mono functional alcohols (monols) has not drawn much attention. A second aspect of the present invention relates to the applicant's discovery of a synthetic route to produce functional polyurethane polymers which comprise urethane bonds and ethylene groups. Functional polyurethanes obtained and/or obtainable by this process may optionally be used as ingredients in the mini-emulsion process of the invention also described herein. The properties of such functional polyurethanes can be varied by using different compounds with a single isocyanate reactive group (such as monols) in the process. When used in the mini-emulsion process such functional polyurethanes can to give improved properties to PSAs of the invention, such as improved moisture vapor transmission rate (MVTR).

Aqueous polymer dispersions have been prepared by mini-emulsion polymerization for several years. This is a method where monomer(s) are dispersed as nano-sized droplets in a continuous aqueous phase formed as a mini-emulsion. The average droplet diameter of mini-emulsion can range from 10 to 1000 nm and can be distinguished from conventional emulsions and emulsion polymerization processes, where the size of the droplets is larger from 1 to 10 μm (microns). In a mini-emulsion method each nano-sized droplet becomes the primary locus for nucleation and polymerization which thus occurs in a highly parallel fashion producing polymer latex particles of about the same size as the initial droplets. Mini-emulsion polymerization offers a number of advantages over conventional emulsion polymerization as for example hydrophobic components may be encapsulated or incorporated into the polymer during the polymerization.

Various mini-emulsions have been described together with methods of stabilizing them.

WO 04/069879 (UCB, now assigned to Cytec) describes use of an amphiphilic stabilizing polymer having a number average molecular weight Mₙ of 800 to 100,000 and an acid number of 50 to 400 mg KOH/g to stabilize the mini-emulsion droplets.

WO 00/29451 (Max Planck) and U.S. Pat. No. 5,686,518 (Georgia Tech) disclose a series of hydrophobic components that are suitable for the stabilization of mini-emulsions. These documents teach that surfactants are needed in addition to these hydrophobic components to stabilize both the emulsion droplets and the polymer particles obtained after polymerization. The surfactants used are: sodium lauryl sulfate or other alkyl sulfates, sodium dodecyl benzene sulfonate or other alkyl or aryl sulfonates, sodium stearate or other fatty acid salts, or polyvinyl alcohol.

US 2002/131941 A1 (BASF) (=EP 1191041) describes colored aqueous polymer dispersions of average particle size below 1000 nm which used as cosmetics. This reference describes a stabilizing system to replace anionic surfactants which are skin irritants comprising from 0.1 to 20% of at least one non-ionic surface active compound (NS) with from 1 to 50% of at least one amphiphilic polymer (PA) having 0.5 to 10 mol/kg of anionic functional groups.

U.S. Pat. No. 6,911,487 (Dow) describes a hybrid polyurethane acrylic polymer formed by a mini-emulsion process. The polyurethane polymer precursor described contains reactive isocyanate groups which are designed to react during the emulsion polymerization to extend the polymer chain backbone. These polymers have an isocyanate character and so are less suitable as a PSA.

A description of typical mini-emulsion is given in chapter one of the thesis for a Doctorate in chemistry presented 30 Mar. 2003 to the University Claude Bernard by Keltoum Ouzineb entitled “Emulsion and mini-emulsion polymerization: stabilization, tubular reactor and practical applications”. This process and any other typical mini-emulsion process conditions known to those skilled in the art may be used in the mini-emulsion step of the process of the present invention.

The following literature references also describe aspects of processes for preparing mini-emulsions and the contents of these papers are hereby incorporated by reference:

### Adv Polym Sci, 175, 129-255, 2005, Mini-emulsion Polym Rev, Schork;

### Adv Polym Sci, 155, 101-165, 2001, Mini-emulsion Polym Rev, Capek;

### Top Curr Chem, 227, 75-123, 2003, Mini-emulsion Polym Rev, Landfester;

Prog. Polym. Sci., 2002, 27, 689, M. Antonietti, K. Landfester; and
Prog. Polym. Sci., 2002, 27, 1283, J. M. Asua.

The present invention overcomes some and/or all of the problems of the prior art.

Therefore broadly in accordance with one aspect of the present invention there is provided a multi step process for preparing an aqueous dispersion of heterogeneous polymer particles by mini-emulsion polymerization, the process comprising the steps of:

(a) forming an aqueous mixture (first mixture) comprising:
(i) water; and
(ii) at least one stabilizer (optionally hydrophilic),
   (b) forming separately from the first mixture a polymer precursor mixture (second mixture) comprising:
(i) at least one functional polyurethane polymer that comprises at least one activated unsaturated moiety and is substantially free of unreacted isocyanate groups;
(ii) at least one α,β-ethylenically unsaturated polymer precursor; and
(iii) optionally at least one co-stabilizer (optionally hydrophobic); and
   where components (i), (ii) and/or (iii) may optionally be the same;
   (c) mixing the first and second mixtures together to form a pre-emulsion;
   (d) applying suitable means, optionally a high shear field, to the pre-emulsion from step (c) to form an essentially stable mini-emulsion comprising an aqueous continuous phase and dispersed therein stabilized droplets of average diameter from about 10 nm to about 1000 nm,
   (e) polymerizing the polymer precursor(s) optionally in the presence of a free radical initiator; to obtain a latex of a hybrid urethane acrylic polymer.

The mini-emulsion process of the invention provides a network of hybrid acrylic polyurethane polymers which may be used to prepare PSAs also of the invention. Such PSAs may exhibit very high shear strength without losing peel strength with improved performance over PSAs prepared by conventional emulsion processes.

Optionally the process of the invention provides a hybrid polymer, where polyurethane side chains may be grafted onto an acrylic polymer backbone.

Preferred ingredients for use in each step of the process of the invention are described below.

Preferably the first (aqueous) mixture obtained from step (a) is a homogenous aqueous system and more preferably the stabilizer is substantially soluble in water under the conditions of use. An example of a composition suitable for use in step (a) is mixture of the surfactants Soprophor 4D384, Abex 2535, and AOT-75 dissolved in dematerialized water.

Preferably the second (polymer precursor) mixture obtained from step (b) comprises a homogeneous oil phase in which substantially all the ingredients used in step (b) are substantially dissolved. An example of the α,β-ethylenically unsaturated polymer precursors suitable for use in step (b) is a mixture of 2-ethylhexyl acrylate, styrene, ethyl acrylate, acrylic acid and β-CEA monomers. An example of the hydrophobic co-stabilizer is polystyrene and an example of the functional polyurethane is a urethane acrylate both of which may be dissolved in the preceding mixture of acrylic monomers.

Preferably the at least one functional polyurethane in step (b) is a (meth)acrylated urethane polymer, more preferably obtained and/or obtainable by the process forming the second aspect of the present invention (and described below). Examples of suitable polymers include the urethane acrylates available commercially as Ebecryl® 230 from Cytec and/or CN3001 from Sartomer.

Preferred α,β-ethylenically unsaturated polymer precursors for use in step (b) are those described herein, more preferably are (meth)acrylate monomers and/or acids thereof.

Preferred hydrophobic co-stabilizers for use in step (b) are those described herein, for example hydrocarbon polymer.

Different polymers types have generally been blended waterborne adhesives to improve the balance between good peel and shear properties. However, their incompatibility with acrylic based (co)polymers compromises the adhesive properties of the blend.

One embodiment of the invention provides a means to obtain hybrid copolymer PSAs of very high shear strength, excellent latex stability and also improved peel strength compared to conventional PSAs or blends prepared by conventional emulsion processes. Little coagulum forms during the process of the invention. Some PSAs of the invention may conveniently replace solvent PSA in high performance applications such as automotive tape applications.

Conventional acrylic emulsion pressure sensitive adhesives also generally have poor peel/shear balance and form films with a poor moisture vapor transmission rate (MVTR).

A further embodiment of the present invention can provide a means to incorporate polyurethane polymers into a conventional acrylic emulsion PSAs to usefully improve their MVTR. Such PSAs may be of particular benefit in replacing solvent based PSA in applications such as medical tapes which require PSAs with a high MVTR.

One preferred aspect of the present invention provides a PSA film of the invention having an MVTR of at least about 400 g/24 hr/m², more preferably at least about 450 g/24 hr/m², most preferably at least about 500 g/24 hr/m², for example at least 550 g/24 hr/m². Unless otherwise indicated the MVTR values given herein are those obtained by standard method ATSM D3833/3833M.

Without wishing to be bound by any mechanism it is believed that the process of the invention using a mini-emulsion incorporates polyurethanes of novel structure with the acrylic polymer network for example by a poly-addition polymerization. The MVTR properties may be adjusted by selecting a particular polyurethane structure for example by the choice of ingredients (such as a monol) used to prepare the polyurethane.

The pre-emulsion may be formed in step (c) of the process, by sufficiently mixing the aqueous phase from step (a) and the oil phase from step (b) to form a thick, white pre-emulsion, which has droplets size generally from 1 to 10 μm or even larger.

The droplet size of pre-emulsion may be further reduced in step (d) by any suitable means (such as described herein) to form a mini-emulsion.

Advantageously the polymer precursors described herein of the present invention may also be used as a component (for example the α,β-ethylenically unsaturated monomer component) to prepare the tackified mini-emulsion compositions described in the applicants co-pending European patent application 06021165.3 (Cytec ref 50.24) the contents of which are incorporated herein by reference. The optional tackifying resin may be selected from one or more suitable hydrophobic tackifier(s) such as polyterpenes, rosin resins and/or hydrocarbon resins for example any of those described in the preceding reference.

It will be appreciated that the polymerization as described herein may be performed as a batch, continuous and/or semi-continuous process.

A further aspect of the invention provides for a particle dispersion and/or PSA obtained and/or obtainable by the process of the invention as described herein.

It is also desirable to prepare a functional polyurethane polymer that comprises at least one activated unsaturated moiety and is substantially free of unreacted isocyanate groups, the functional polyurethane optionally being suitable for use in step (b) of the mini-emulsion process of the invention.

Therefore another aspect of the present invention provide a process for preparing a functional polyurethane polymer comprising the step of polymerization in the presence of a suitable catalyst and/or free radical inhibitor of:

(1) an isocyanate functional polymer precursor (e.g. isocyanate functional monomer) together with
(2) at least one compound with a single isocyanate reactive group (e.g. a monol); and/or
(3) at least one α,β-ethylenically unsaturated polymer precursor; where components (2) and (3) may optionally be the same;
to obtain a functional polyurethane polymer that optionally comprises at least one activated unsaturated moiety and is substantially free of unreacted isocyanate groups.

Optionally the functional polyurethane prepared above may comprise any of those described herein as suitable for use in step (b) of the process which is the first aspect of the present invention. The optional α,β-ethylenically unsaturated polymer precursor (ingredient (3) of the above ‘isocyanate’ process that optionally may be used to prepare functional polyurethanes) may be the same or different as the corresponding component used in step (b) (ii) of the mini-emulsion process of the invention.

Optionally if the mono-functional isocyanate reactive compound (2) and the α,β-ethylenically unsaturated polymer precursor (3) are the same they may comprise a mono hydroxy substituted derivative of any of the α,β-ethylenically unsaturated polymer precursors described herein, such as hydroxy alkyl(meth)acrylate and/or hydroxy ethyl acrylate.

Optionally ingredients (2) (isocyanate reactive compound) and/or (3) (α,β-ethylenically unsaturated monomer) are present in an excess to react with substantially all of the isocyanate.

### Ingredients Usable in the Process(es) of the Present Invention

### Functional Polyurethane (for Example Vinyl Terminated Polyurethane)

It will be appreciated that any suitable functional polyurethanes can be used in step(b) (i) of the mini-emulsion process of the invention. It is not a requirement that the functional polyurethanes are produced using the isocyanate process of the invention as described above or by reacting any isocyanate. The functional polyurethanes used herein may comprise any suitable that are obtained or obtainable using other reactions well known to persons skilled in the art. Non limiting examples of non-isocyanate processes that may produce functional polyurethanes for use herein include:

reacting suitable compounds comprising terminal cyclocarbonate groups with suitable compounds comprising terminal primary amine groups (such as described in U.S. Pat. No. 6,120,905);
reacting suitable carbonated vegetable oils with suitable polyamines (such as described in U.S. Pat. No. 7,045,577), and/or
transesterifying suitable hydroxyalkyl carbamates with suitable (meth)acrylate(s) and suitable carbonates and/or diesters, for example as described in WO 05-110978 where the (meth)acrylate is of formula [CH₂═CRⁱ—CO—O—]ₜ—Rⁱⁱ (where t≧1, Rⁱ is hydrogen or methyl, and Rⁱⁱ is an alkyl, optionally substituted by hydroxy, which may contain from 1 to 10 ether bridging groups, from 1 to 10 —CO— bridges and/or from 1 to 5 —O—CO— bridges); the carbonate is of formula RⁱⁱⁱO(C═O)OR^{iv}; and the diester is of formula R^{v}O(C═O)R^{vi}(C═O)OR^{vii} (where each Rⁱⁱⁱ, R^{iv}, R^{v}, and R^{vii} is independently alkyl and/or aryl, and R^{vi} is alkylene, alkenylene or arylene).

Preferred functional polyurethanes are those obtained and/or obtainable by polymerizing suitable isocyanate polymer precursors optionally in the presence of other suitable reactants, as for example in the isocyanate process of the invention described above. Suitable isocyanates for use in this process are described more fully below.

Useful isocyanate(s) may comprise mono or poly(isocyanates), more usefully mono or di-isocyanates, most usefully aromatic and/or aliphatic isocyanates. Examples of suitable isocyanates are selected from the group consisting of; tetramethylene di-isocyanate, hexamethylene di-isocyanate, dodecamethylene di-isocyanate, 1,4-diisocyanatocyclohexane, 3-isocyanatomethyl-3,3,5-trimethylcyclohexylisocyanate (isophorone di-isocyanate), 4,4′-diisocyanatodicyclohexylmethane, 4,4′-diisocyanato-3,3′-dimethyldicyclohexylmethane, 4,4′-diisocyanatodicyclohexylpropane-(2,2), 1,4-diisocyanatobenzene, 2,4- or 2,6-diisocyanato-toluene and/or mixtures of these isomers, 4,4′-, 2,4′- or 2,2′-diisocyanatodiphenylmethane and/or mixtures of these isomers, 4,4′-diisocyanatodiphenylpropane-(2,2), p-xylylene di-isocyanate and/or α,α,α′,α′-tetramethyl-m- or -p-xylylene di-isocyanate, unsaturated aliphatic isocyanate and/or mixtures of any of the these compounds.

Particularly preferred aromatic di-isocyanates are toluene di-isocyanate (TDI). Particularly preferred aliphatic di-isocyanates are selected from isophorone di-isocyanate (IPDI), dimethyl methylene-bis-cyclohexylisocyanate, 1,6-hexane di-isocyanate and/or tetramethylxylene di-isocyanate. Particularly preferred aliphatic isocyanates are dimethyl meta-isopropenyl benzyl isocyanate (such as that available from Cytec under the trade designation TMI). Examples of isocyanates are TDI, TMI and/or IPDI.

The higher functional isocyanates known from polyurethane chemistry and known modified isocyanates, such as mono or poly-isocyanates containing carbodiimide groups, allophanate groups, isocyanurate groups, urethane groups, and/or biuret groups, may, of course, also be used to form all or part of the polyurethanes used herein.

The functional polyurethanes used in the process of the present invention may also comprise an activated ethylenically unsaturated group such as those described herein (for example α,β-ethylenically unsaturated group(s), e.g. (meth)acrylate(s) and/or vinyl group(s)). Preferred functional polyurethanes used herein comprise (meth)acrylated polyurethanes.

The polyurethanes used herein may conveniently be prepared in the presence of other suitable materials such as suitable catalyst(s) (such as dibutyl tin laurate and/or, dibutyl tin dilaurate (DBTDL)), inhibitor(s) (such as 2,6-di-tert-butyl-4-methylphenol, 4-methoxyphenol (MEHQ) and/or hydroquinone (HQ)) and/radical scavenger(s) (such as 2,6-di-tert-butyl-4-methylphenol (butyl hydroxy toluene-BHT)).

The amount of functional polyurethane used in the mini-emulsion process of the invention (in step (b) (i)) may be generally from about 0.1% to about 70%, preferably from about 0.5% to about 60% by weight calculated relative to the total weight of the mixture prepared in the same step.

### Isocyanate Reactive Compounds (Such as Monols Usable in the Isocyanate Reaction)

The isocyanate reactive compound used as ingredient (2) in the isocyanate process of the invention comprises a single group which is capable of reacting with an isocyanate under the conditions of the reaction (mono-functional isocyanate-reactive). A preferred isocyanate reactive group is selected from, carboxy, thiol, hydroxy or amino, more preferably hydroxy or amino. Usefully the isocyanate reactive compound is a monol (i.e. comprises one hydroxy optionally with other functionality that does not substantially react with isocyanate under the conditions of the reaction). More useful monols comprise any suitable mono hydroxy substituted derivative of any of the α,β-ethylenically unsaturated polymer precursors described herein and/or any of the stabilizers described herein.

Most usefully the monols may comprise the (meth)acrylate monomers: hydroxyalkyl (meth)acrylate and/or hydroxy ethyl acrylate and/or may comprise the surfactants Soprophor BSU, Soprophor S/40 (both from Rhodia), and/or methoxy polyethylene glycol (MPEG, from Dow).

### Alpha(α), Beta(β)-Ethylenically Unsaturated Polymer Precursor(s) (e.g. (Meth)Acrylate Monomer(s))

The α,β-ethylenically unsaturated polymer precursors that may be used in the process of the invention will now be described.

The α,β-ethylenically unsaturated monomers described below may be used in different ways, for example these monomers:

may comprise some or all of the α,β-ethylenically unsaturated polymer precursor(s) used in the mini-emulsion process of the invention (e.g. step(b) (ii));
may be polymerized (optionally in a separate step) to form polymerizible polymers and/or oligomers (with α,β-ethylenically unsaturated group(s) thereon), which may then comprise some or all of the α,β-ethylenically unsaturated polymer precursors used in the mini-emulsion process of the invention (e.g. step(b) (ii)); and/or
may comprise the α,β-ethylenically unsaturated ingredient (3) used in the isocyanate process of the invention for preparing functional polyurethane polymer(s) suitable for use in the mini-emulsion process of the invention (e.g. step(b) (i)).

The amount of α,β-ethylenically unsaturated polymer precursors used in the process(es) of the invention may be generally present in an amount from about 10% to about 70%, preferably from about 18% to about 60% by weight. Unless otherwise indicated, for the mini-emulsion process of the invention these polymer precursor weights are calculated relative to the total weight of the mini-emulsion prepared in step (e); and for the isocyanate process of the invention are calculated relative to the total weight of ingredients (1), (2) and (3).

Useful α,β-ethylenically unsaturated monomers comprise one or more of the following and/or mixtures and combinations thereof:

alkyl(meth)acrylates, more preferably methyl acrylate, methyl methacrylate, ethyl acrylate, ethyl methacrylate, butyl acrylate, butyl methacrylate, 2-ethyl hexyl acrylate, cyclohexyl methacrylate, 2-ethyl hexyl methacrylate, stearyl methacrylate, isobornyl methacrylate and/or lauryl methacrylate, most preferably methyl methacrylate, methyl acrylate, n-butyl acrylate, ethyl acrylate and/or, 2-ethylhexyl acrylate,
polymerizible aromatic compounds; more preferably styrenes, most preferably styrene, α-methyl styrene, vinyl toluene and/or t-butyl styrene,
polymerizible nitriles; more preferably acrylonitrile and/or methacrylonitrile,
polymerizible amide compounds,
α-olefin compounds such as ethylene,
vinyl compounds; more preferably vinyl esters (most preferably vinyl acetate, vinyl propionate and/or longer chain vinyl ester homologues) vinyl ethers, vinyl halides (most preferably vinyl chloride) and/or vinylidene halides,
diene compounds more preferably butadiene and/or isoprene.

α,β-ethylenically unsaturated monomers comprising fluorine and/or silicon atoms, more preferably 1H, 1H, 5H-octafluoropentyl acrylate and/or trimethylsiloxyethyl acrylate.

Advantageous α,β-ethylenically unsaturated monomers are selected from styrenes, acrylates, methacrylates, vinyl and vinylidene halides, dienes, vinyl esters and mixtures thereof; more advantageously from methyl methacrylate, styrene, vinyl acetate, methyl acrylate, butyl acrylate, ethyl acrylate, 2-ethylhexyl acrylate, butadiene and vinyl chloride.

Optionally the polymer precursor second mixture in step (b) (ii) the present invention may comprise any combination of the following monomers as defined below (optionally in combination with any of the α,β-ethylenically unsaturated monomers described previously):

(i) at least one hydrophobic polymer precursor (Component I),
(ii) at least one hydrophilic polymer precursor (Component II);
(iii) at least one partially hydrophilic polymer precursor (Component III); and/or
(iv) at least one polymer precursor comprising a cyclic amide moiety (Component IV).

Unless otherwise indicated (e.g. for amounts of aryl arylalkylene within Component I) all of the weight amounts described herein for the following monomers are given as weight percentages by the total weight of these monomers (Components I, II, III & IV).

Component I (e.g. Hydrophobic Monomer)

Component I comprises, conveniently consists essentially of, at least one hydrophobic polymer precursor comprising at least one activated unsaturated moiety (conveniently at least one hydrophobic (meth)acrylate monomer) and/or arylalkylene polymer precursor.

Preferably the hydrophobic (meth)acrylate comprises C_{>4}hydrocarbo (meth)acrylate(s) and conveniently the C_{>4}hydrocarbo moiety may be C₄₋₂₀hydrocarbyl, more conveniently C₄₋₁₄alkyl most conveniently C₄₋₁₀alkyl, for example C₄₋₈alkyl.

Suitable hydrophobic (meth)acrylate(s) are selected from: isooctyl acrylate, 4-methyl-2-pentyl acrylate, 2-methylbutyl acrylate, isoamyl acrylate, sec-butyl acrylate, n-butyl acrylate, 2-ethylhexyl acrylate, isodecyl methacrylate, isononyl acrylate, isodecyl acrylate, and/or mixtures thereof, especially 2-ethylhexyl acrylate and/or n-butyl acrylate, for example 2-ethylhexyl acrylate.

Preferably the arylalkylene comprises (optionally hydrocarbo substituted) stryene and conveniently the optional hydrocarbo may be C₁₋₁₀hydrocarbyl, more conveniently C₁₋₄alkyl.

Suitable arylalkylene monomers are selected from: styrene, α-methyl styrene, vinyl toluene, t-butyl styrene, di-methyl styrene and/or mixtures thereof, especially styrene.

The arylalkylene monomer may be present in Component I (the total hydrophobic monomer) up to about 30%, preferably from about 1% to about 20%, and more preferably from about 5% to about 15% by total weight of Component I.

The currently preferred Component I is a mixture of 2-ethylhexyl acrylate and/or n-butyl acrylate with styrene, more preferably a mixture of 2-ethylhexyl acrylate and stryene.

Component I may be present in a total amount from about 70% to about 90%, preferably from about 75% to about 85% by weight.

Component II (e.g. Hydrophilic Monomer)

Component II comprises suitable hydrophilic polymer precursors are those that are co-polymerizible with the hydrophobic polymer precursors(s) of Component I and are water soluble. Conveniently the at least one hydrophobic polymer precursor may comprise at least one activated unsaturated moiety.

Preferred hydrophilic monomers comprise, advantageously consist essentially of, at least one ethylenically unsaturated carboxylic acid. More preferred acids have one ethylenic group and one or two carboxy groups. Most preferably the acid(s) are selected from the group consisting of: acrylic acid (and oligomers thereof), beta carboxy ethyl acrylate, citraconic acid, crotonic acid, fumaric acid, itaconic acid, maleic acid, methacrylic acid and mixtures thereof; for example acrylic acid, methacrylic acid, beta carboxy ethyl acrylate and mixtures thereof.

The currently preferred Component II is a mixture of beta carboxy ethyl acrylate and acrylic acid.

Component II may be present in a total amount of at least about 1%, preferably from about 2% to about 10%, more preferably from about 3% to about 9%, most preferably from about 4% to about 8% by weight.

### Component III (Partially Hydrophilic Monomer)

Component III comprises partially hydrophilic polymer precursor(s) and/or partially water soluble monomers and conveniently may comprise at least one activated unsaturated moiety.

Preferred partially hydrophilic monomers comprise, conveniently consist essentially of, at least one C₁₋₂alkyl(meth)acrylate. More preferred partially hydrophilic monomers are selected from the group consisting of: methyl acrylate, methyl methacrylate, ethyl acrylate and mixtures thereof; most preferably ethyl acrylate, methyl methacrylate, and mixtures thereof, for example ethyl acrylate.

The currently preferred Component III is ethyl acrylate.

Component II may be present in a total amount of up to 10%, preferably from about 0.1% to about 5%, more preferably from about 0.1% to about 3%, most preferably from about 0.5% to about 2.5% by weight.

### Component IV (Cyclic Amide Monomer)

Preferred monomers with a cyclic amide moiety are represented by Formula 4

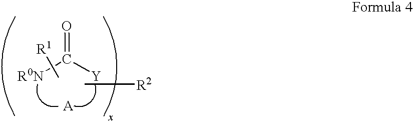

where:
Y denotes an electronegative group,
R⁰ is H, OH or an optionally hydroxy substituted C₁₋₁₀hydrocarbo
R¹ is H or a C₁₋₁₀hydrocarbo;
R² is a C₁₋₁₀hydrocarbo group substituted by at least one activated unsaturated moiety; and
A either represents a divalent organo moiety attached to both the HN and Y moieties so the A, NH, C═O and Y moieties together represent a ring having from 4 to 8 ring atoms, and R¹ and R² are attached to any suitable point on the ring; or
A is not present (i.e. Formula 4 is linear and/or branched does not contain a heterocyclic ring) in which case R¹ and R² are attached to the R⁰ moiety,
x is an integer from 1 to 4;

Conveniently Component IV consists essentially of, at least one monomer of Formula 4 as defined herein.

Usefully in Formula A the ring moiet(ies) are each attached to R² and in Formula 4 when x is 2, 3 or 4 then R² is multi-valent (depending on the value of x). If x is not 1 R¹ and Y may respectively denote the same or different moieties in each ring, preferably the same respective moieties in each ring. R¹ and R² may be attached at any suitable position on the ring.

Preferred monomers of Formula 4 comprise, conveniently consist essentially of, those where:

A represents a optional substituted divalent C₁₋₅hydrocarbylene; and
Y is divalent NR (where R′ is H, OH, optionally hydroxy substituted C₁₋₁₀hydrocarbo or R²) or divalent O,

More preferred monomers of Formula 4 comprise those where:

x is 1 or 2
Y is NR² (i.e. where Formula 1 is attached to R² via a ring nitrogen)
A represents a divalent C₁₋₃hydrocarbylene;

### R⁰ is H,

R¹ is a C₁₋₁₀hydrocarbo; and
R² comprises a (meth)acryloxy hydrocarbo group or derivative thereof (e.g. maleic anhydride); and

Most preferred monomers of Formula 4 comprise those where:

x is 1, or 2 and the (optionally repeating) unit in Formula 1 is represented by Formula 6

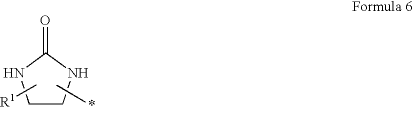

where the asterisk denotes the point of attachment of Formula 6 to R² (which may be at any suitable point on the ring preferably via a ring nitrogen); and
R¹ is H or C₁₋₈hydrocarbyl
R² comprises a (meth)acryloxyC₁₋₁₀hydrocarbo group.

More preferred monomers of Formula 4 comprise:

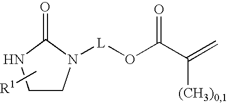

where R¹ is H or C₁₋₆alkyl and L is a suitable divalent organo linking group (such as C₁₋₁₀hydrocarbylene, for example C₁₋₆alkylene).

Further suitable ureido monomers of Formula 4 are described in “Novel wet adhesion monomers for use in latex paints” Singh et al, Progress in Organic Coatings, 34 (1998), 214-219, (see especially sections 2.2 & 2.3) and EP 0629672 (National Starch) both of which are hereby incorporated by reference.

Examples of monomers of Formula 4 are selected from:

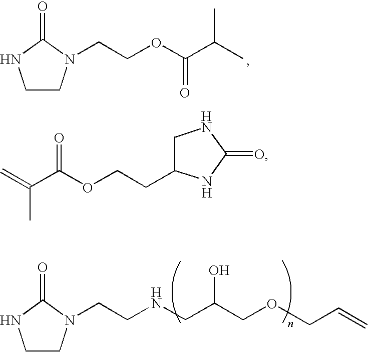

(where n is 1 to 4),

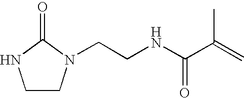

(available commercially from Atofina under the trade mark Sipomer® WAM II) and suitable mixtures thereof.

In the same and/or another embodiment of the invention monomers as described in U.S. Pat. No. 6,166,220 (Cytec Technology Corporation, the disclosure of which is hereby incorporated by reference) may used to comprise all or part of Component IV and/or Formula 4 herein and/or may also be incorporated in the formulations of the invention. Preferably such monomers are represented by formula “B(C═O)Y(C═O)A” on col. 2 line 25 of U.S. Pat. No. 6,166,220 (where B, Y and A are as described therein). Such monomers may be available commercially from Cytec under registered trade mark Cylink®. Examples of suitable such monomers are those available under the following trade designations: Cylink® NMA and/or NMA-LF (self cross-linking monomers), Cylink® IBMA (an isobutoxy derivative of Cylink® NMA), Cylink® MBA; Cylink® NBMA, Cylink® TAC and/or Cylink® C4 (a wet adhesion monomer).

Conveniently Component IV may be used as a substantially pure compound (or mixture of compounds) of Formula 1 or may be dissolved in a suitable solvent such as a suitable (meth)acrylate or acrylic derivative for example methyl methacrylate. Optionally such solutions may comprise from about 50% to about 75% by weight of Component IV.

Component IV may be present in a total amount from at least about 0.1%, preferably from about 0.1% to about 2.0%, more preferably from about 0.2% to about 1.0%, most preferably from about 0.3% to about 0.6% by weight.

### Stabilizer

As used herein the term “stabilizer” denotes any suitable species that is used to increase the stability of the dispersions used in or of the invention and the term “stabilizer” comprise one or more of any species that may also be referred to by other terms such as colloidal stabilizer, detergent, dispersing agent, emulsifier, surfactant and/or surface active agent (for example, any substance that may be added to a liquid to increase its spreading or wetting properties by reducing its surface tension), wetting agent and/or any other terms well known to those skilled in the art to refer to similar or analogous species that perform a similar or analogous function to any of the preceding.

The amount of stabilizer used is that amount effective to produce a latex emulsion having particles having an average particle size described herein. The effective amount needed to obtain the required particle size will be dependent on operating conditions known in the art to have an affect on particle size, including agitation (shear), viscosity, and the like. The stabilizer can be added at the beginning of the polymerization, to form a pre emulsion, in batches during polymerization and/or with monomers.

In step (a) of the mini-emulsion process of the invention optionally hydrophilic stabilizer(s) may be used.

Usefully the stabilizer comprises a hydrophilic surfactant, more usefully at least one ionic surfactant, optionally together with at least one non-ionic surfactant. Most usefully the ionic surfactant may comprise at least one aromatic ionic surfactant.

Optionally at least one of the aromatic ionic surfactant (a) (i) and/or (a) (iii) has a HLB value from about 8 to about 20, preferably from about 10 to about 18, more preferably from about 12 to about 17, for example about 16.

Conveniently at least one of the aromatic ionic surfactants is represented by Formula 1

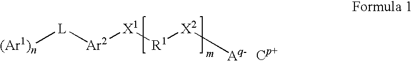

where Ar¹ and Ar² independently in each case each represent C₆₋₁₈hydrocarbo comprising an aromatic moiety,
L is a divalent organo linking group or direct bond, where optionally Ar¹ and Ar² may together form a fused ring;
R¹ is an optionally substituted C₁₋₈hydrocarbylene, more preferably C₁₋₆alkylene;
X¹ and X² independently in each case each represent O, S, CH₂, NH or NR³ where R³ represents optionally substituted C₁₋₂₀hydrocarbyl, more preferably C₁₋₁₀alkyl;
A represents a S(O)₁₋₃ or P(O)₁₋₃ moiety and q is from 1 to 3;
C is a suitable counter cation and p balances the charge q;
m represents an integer from 1 to 70, preferably from 5 to 60; more preferably from 10 to 50; most preferably from 10 to 30 for example about 16;
n represents an integer 1 to 6, optionally 1 to 3.

More conveniently the at least one ionic surfactant of Formula 1 is represented by Formula 1a

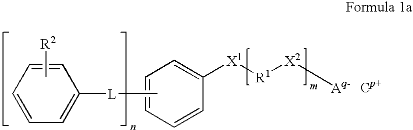

where L, R¹, X¹, X², A, C, q, p, n and m are as given for Formula 1, and R² is an optionally substituted C₁₋₈hydrocarbylene, more preferably C₁₋₆alkylene.

More preferably in Formula 1a

L, R¹ and R² are independently in each case C₁₋₄alkylene, more preferably —CHCH₂(CH₃)—, —CH(CH₃)— or —CH₂CH₂—,
X¹ and X² independently in each case O, S, NH or —N(C₁₋₆alkyl)-, most preferably O,

### A is a S(O)₃ or P(O)₃ and q is 1

C is a suitable counter cation and optionally p is 1;
n is from 1 to 3 more preferably 3, and m is from 10 to 30, most preferably 10 to 20.

Most preferred surfactants of Formulae 1 and 1a are those that are obtained and/or obtainable by the reaction of styrene and phenol and subsequent phosphation and/or sulfation of the resultant alkoxylated multiply styryl substituted phenol (such as tristryryl phenol and/or derivatives thereof).

Particularly preferred tristryryl phenol ionic surfactants of Formulae 1 and 1a are those available from Rhodia under the following trade designations:

Soprophor 30-33 (an ethoxylated phosphate ester free acid);
Soprophor 3D-33/LN (a low non ionic ethoxylated phosphate ester free acid);
Soprophor 3D-FLK (an ethoxylated phosphate ester potassium salt);
Soprophor 3D-FL (an ethoxylated phosphate TEA (triethylamine) salt);
Soprophor 3D-FL-60 (an ethoxylated phosphate TEA (triethylamine) salt);
Soprophor 4D-384 (an ethoxylated sulfate, ammonium salt);
Soprophor 40-360 (an ethoxylated sulfate, ammonium salt); and/or any suitable mixtures thereof.

An exemplified surfactant may be represented by

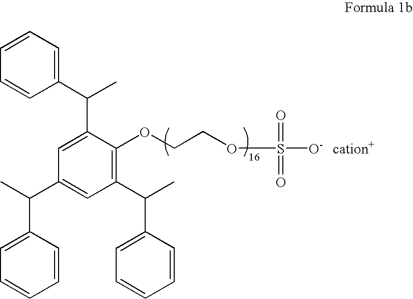

which (when the cation is ammonium) is available from Rhodia under the trade designation Soprophor 4D384.

In an alternative embodiment optionally substituted derivatives of alkylene naphthyl sulfonate available commercially from King Industries may be used as the ionic, surfactant.

Conveniently the further aromatic ionic surfactant (a) (iii) may be represented by Formula 2

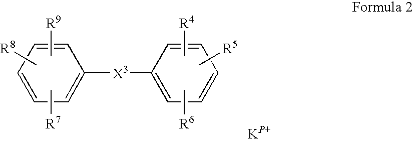

in which
X³ represents O, S, CH₂, NH or NR¹⁰ where R¹⁰ represents optionally substituted C₁₋₂₀hydrocarbyl, more preferably C₁₋₁₀alkyl,
from 1 to 4 (preferably 1 to 2) of the radicals R⁴ to R⁹ are at least one electronegative substituent formed from a hard acid, preferably selected from a mono valent oxy substituted sulfo anion, and/or a mono valent oxy substituted phospho anion, more preferably —S(O)₁₋₃^{Q-} or P(O)₁₋₃^{Q-} moiety where Q is from 1 to 3;
and the remainder of R⁴ to R⁹ are independently H or C₁₋₃₀hydrocarbyl, preferably H or C₁₋₂₀alkylene; and
K^{P+} is a counter cation where ‘P’ is ‘Q’.

Particularly preferred ionic surfactants of Formula 2 are di-sodium mono- and di-dodecyl di-phenyl oxide di-sulfonates such as

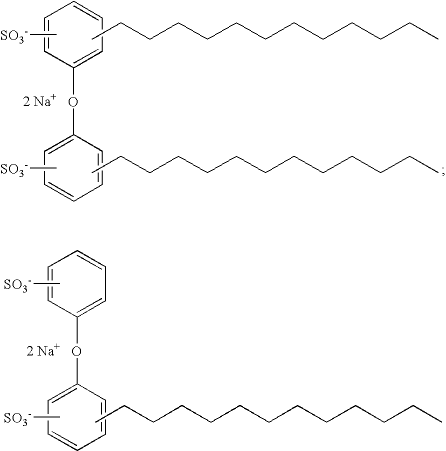

and/or mixtures thereof such as the mixture available from Cytec under the trade designation DPOS-45.

An alternative optional further ionic surfactant(s) comprises those of the following formula

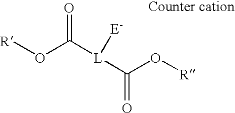

where E is the electronegative group, preferably SO₃ or PO₂,
L is a trivalent organo linking group, preferably C₁₋₄alkylene; and
R′ and R″ are independently each H or optionally substituted C₁₋₃₀ hydrocarbyl

More preferred optional other ionic surfactants are represented by

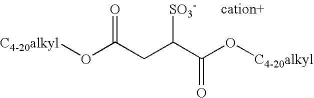

An example of such an optional other ionic surfactant is sodium dioctyl sulfosuccinate which is available commercially from Cytec under the trade name Aerosol OT.

Surfactants of Formulae 1 and/or 1a are preferred to those of Formulae 2 and/or 2a and usefully the surfactant mixture comprises at least one surfactant of Formulae 1 and/or 1a.

The surfactant mixture may optionally further comprise another ionic surfactant selected from a polycarboxylic acid and/or ester substituted by at least one electronegative substituent formed from a strong acid, preferably selected from a mono valent oxy substituted sulfo anion, and/or a mono valent oxy substituted phospho anion.

Particularly preferred mixture of surfactants that may be used to prepare the aqueous first mixture in step (a) of the mini-emulsion process of the present invention comprise a mixture of:

tristyrylphenol ethoxylate(s) (e.g. Soprophor 40384);
aliphatic non-ionic surfactant(s) (such as alkoxy polyalkylene glycol(s), for example Abex 2535); and
aliphatic ionic surfactant(s) (such as sodium dioctyl sulfosuccinate—Aerosol-OT-75).

Non ionic equivalents of the ionic surfactants described herein may be used as the stabilizer (such as aryl phenol alkoxylate(s). Non-ionic tristryryl phenol surfactants where the anionic substituent in the Formulae above (e.g. Formulae 1, 1a, & 1b) are replaced by hydroxy or H these compounds may be particularly preferred for use as the stabilizer herein. For example where the sulfo group in Formula 1b is replaced by H such tristryryl phenol compounds (available from Rhodia under the trade designation Soprophor BSU) may be used as the monol component herein. An analogous monol compound where the EO repeat unit is 40 (available from Rhodia under the trade designation Soprophor S/40) may also be used.

The optionally non-ionic surfactant may be any suitable, such as an aliphatic non ionic surfactant of Formula 3

R¹¹—X⁴—(Z—X⁵)_{w}H Formula 3

where
R¹¹ represents optionally substituted C₁₋₅₀hydrocarbyl, more preferably C₁₋₃₀alkyl; more preferably C₁₋₂₀alkyl;
X⁴ and X⁵ independently in each case each represent O, S, CH₂, NH or NR¹² where R¹² represents optionally substituted C₁₋₂₀hydrocarbyl, (optionally C₁₋₁₀alkyl), more preferably X⁴ and X⁵ independently are O, S, NH or —N(C₁₋₆alkyl)-, most preferably O,
Z represents C₁₋₄alkylene, more preferably —CHCH₂(CH₃)—, —CH(CH₃)— or —CH₂CH₂—, CH—CH₂ or

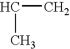

and
‘w’ represents an integer from 1 to 50, preferably 1 to 30, more preferably 5 to 20.

Particularly preferred non-ionic surfactants are those mixtures of aliphatic non ionic surfactants available from Rhodia under the trade designation Abex 2535.

The total amount of surfactant used to make the emulsion of the invention based on the total weight of monomers is about 0.1 to about 5% by weight, preferably from about 0.5 to about 2% by weight of the ingredients used in step (b).

In step (b) of the mini-emulsion process of the invention optionally co-stabilizer(s) may be used optionally in combination with any other suitable stabilizer(s). The co-stabilizer used in step (b) may comprise mixtures of polymer, surfactant and/or colloidal stabilizer. Preferably the co-stabilizer is hydrophobic.

The co-stabilizer may comprise a plurality of co-stabilizers optionally at least one of which is reactive (i.e. which participate in subsequent polymerization). Reactive co-stabilizer(s) can be used either with or without additional non-reactive co-stabilizer(s).

Preferred reactive co-stabilizers comprise one or more of the following:

hydrophobic (co)monomers, more preferably acrylates, most preferably stearyl acrylate and/or long chain (meth)acrylates,
macromonomers;
hydrophobic chain transfer agents, more preferably dodecyl mercaptane, octadecyl mercaptane and/or other long chain mercaptanes;
hydrophobic initiators, more preferably 2,5-dimethyl-2-5-di(2-ethylhexanoylperoxy) hexane and other long chain (hydro)peroxides, and/or azo initiators
any of the amphiphilic stabilizing polymers and/or hydrophobic co-stabilizers described WO 04/069879;
suitable hydrocarbon polymers, such as polystryene (PS) and/or poly methyl methacrylate (PMMA) and/or
suitable mixtures and/or combinations thereof.

Usefully the co-stabilizer(s) are selected from C₁₂₋₂₄alkanes (especially hexadecane), C₁₂₋₂₄alcohols, C₁₈₋₂₂acrylates (especially the mixture of acrylates available commercially from Atofina under trade name Norsocryl™ A-18-22); and/or mixtures thereof.

Conveniently a (co)monomers may be selected which functions both as the co-stabilizer and the α,β-ethylenically unsaturated monomer, in which case the amount of such (co)monomer(s) can be as high as about 70% by weight. Generally the co-stabilizer may be added in an amount from about 0.05% to about 40% by weight. Especially when the co-stabilizer is not a (co)monomer, the amount of co-stabilizer is preferably from about 0.1% to about 10%, more preferably from about 0.2% to about 8% and most preferably from about 0.5% to about 5% by weight. The weights of co-stabilizer used herein are calculated relative to the total weight of the polymer precursor mixture prepared in step (b) of the process of the invention.

### Process

Further optional features about the process steps of the present invention will now be provided below.

Each steps of the method of the invention may be independently carried out under any suitable conditions selected depending on the reagents used. Conveniently any of the steps may be carried out at any suitable temperatures between the freezing point and the boiling point of the various mixture(s) and the components present therein, more conveniently from about 0° C. to about 100° C., most conveniently at about ambient temperature. Conveniently the steps may be carried out under pressures from about 0.01 to about 100 atmosphere, more conveniently at about atmospheric pressure.

Step (a) Forming the Aqueous First Mixture (e.g. Solution of Hydrophilic Stabilizer)

According to a still further aspect of the process of the present invention, in addition to the α,β-ethylenically unsaturated monomer(s) one or more water-soluble monomers (denoted herein as secondary monomers) may be added to the aqueous mixture formed during step (a). These optional secondary monomers may comprise ethylenically unsaturated organic compounds which can undergo addition polymerization. Preferred secondary monomers have a water solubility (measured at 25° C., as a percentage of grams of dissolved monomer per 100 grams of water) higher than about 15%. Conveniently secondary monomers may be used only in the presence of at least one α,β-ethylenically unsaturated monomer and only in small percentages in such a monomer mixture. Preferably the amount of optional secondary monomer in such a monomer mixture is less than about 10%, more preferably from about 0.1% to about 5%, and most preferably from about 0.1% to about 3% by weight relative to the total monomer weight.

Preferred secondary monomers are acrylic acid, methacrylic acid, 2-sulfoethyl methacrylate, and/or maleic anhydride. Using secondary monomers in the process of the invention can impart desired properties to the coatings produced from the resultant polymer dispersions.

The formation of the aqueous first mixture in step (a) preferably is performed at a temperature of from about 0° C. to about 100° C., preferably at about ambient temperature.

The mixture formed in step (a) may also contain one or more components that modify pH although this is not always necessary. For example if the aqueous mixture comprises a stabilizing amphiphilic polymer with carboxylic acid groups (see below), it may be useful to prepare and polymerize the mini-emulsion at a high pH for the stabilizing polymer to exhibit the desired amphiphilicity. For such carboxylic acid functional polymers a suitable pH range may be from about 6.0 to about 10.0, preferably from about 7.5 to about 10.0, depending on the nature of the other components of the amphiphilic polymer. When the stabilizing polymer comprises acid functions derived from sulfonic acid, sulfate, phosphate or phosphonate, a suitable range of pH may be from about 2.0 to about 10.0.

Compounds capable of adjusting pH may comprise: ammonia, amines (for example triethyl amine, triethanol amine, dimethylamino hydroxypropane), carbonate salts (for example sodium carbonate), bicarbonate salts (for example sodium bicarbonate), hydroxides (for example sodium hydroxide) and/or oxides (for example calcium oxide). Preferred pH-adjusting compounds are strong bases, optionally selected from an alkali metal hydroxides (such as sodium hydroxide) and/or ammonia.

The pH-adjusting compound may be added during step (a) of the process of the invention, preferably before amphiphilic polymer is added to the mixture.

Optionally Preparing the Aqueous First Mixture from Pre-Mixtures

In a yet other aspect of the process of the present invention, in step (a) the aqueous first mixture may be conveniently formed by mixing a first pre-mixture comprising the amphiphilic stabilizing polymer and water with a second pre-mixture comprising a hydrophobic co-stabilizer and α,β-ethylenically unsaturated monomer(s).

The first pre-mixture may be prepared by adding the amphiphilic stabilizing polymer to water, preferably at a temperature from about 0° C. to about 100° C., followed by the addition of one or more optional ingredients (as described and in the amounts described herein): such as secondary water soluble monomer(s); pH adjusting compound(s) and/or polymerization initiator(s).

If the first pre-mixture is prepared using an amphiphilic stabilizing polymer comprising carboxylic acid function(s) then pH-adjusting compound(s) may be added to adjust the solubility (as measured at 25° C.) of the amphiphilic polymer in the first pre-mixture (i) to at least about 1×10⁻² g/l, more preferably at least about 1×10⁻¹ g/l, and most preferably at least about 1 g/l. It is preferred to add the pH-adjusting compound to the amphiphilic polymer before the polymer is added to the water and to any optional additional components of the first pre-mixture.

The second pre-mixture may be prepared by adding the desired amount of hydrophobic co-stabilizer to the α,β-ethylenically unsaturated monomer(s), preferably under gentle agitation. It is also preferred to prepare the second pre-mixture at room temperature, more preferably until a clear solution is obtained. Optionally one or more secondary water-soluble monomers (as described herein) and/or a polymerization initiator may also be added to the second pre-mixture.

### Step (b) Forming the Polymer Precursor Second Mixture (e.g. (Meth)Acrylate Monomers, Functional Polyurethane & Stabilizer):

Generally the ingredients described herein for the polymer precursor second mixture are mixed together by any suitable means in a suitable vessel. Depending on the choice of ingredients the mixture may form one homogenous phase or may form a dispersion or emulsion with a continuous and dispersed phases. A substantially homogenous mixture is preferred for example where the co-stabilizer and functional polyurethane are substantially dissolved in α,β-ethylenically unsaturated monomer(s).

Step (c) Forming Pre-Emulsion (e.g. Oil-in-Water Macro-Emulsion)

The aqueous first mixture and (optionally hydrophobic) polymer precursor second mixture may be mixed together by any suitable means to form a pre-(macro)-emulsion, i.e. where the droplets are macro sized. The pre-emulsion may comprise a continuous aqueous phase and a dispersed phase of oil droplets. But it will also be understood that if the second mixture does not form a homogenous phase (i.e. is itself an emulsion) it may be possible that the pre-emulsion may form a system with multiple phases e.g. the dispersed droplets may not be homogenous but themselves comprise an emulsion with a continuous and dispersed phase within the oil droplets. For example the pre-emulsion may form a triple phase water-in-oil-in-water emulsion. For such systems the droplet sizes described herein refer to the larger hydrophobic oil droplets dispersed in the main continuous aqueous phase.

Step (d) Forming the Mini-Emulsion (e.g. with High Shear)

Preferably in the process of the invention, the pre-emulsion is mixed optionally under high shear until an essentially stable mini-emulsion is formed which comprises stabilized droplets having a average diameter from about 10 to about 900 nm, more preferably from about 50 to about 500 nm, most preferably from about 80 to about 450 nm, for example from about 100 to about 430 nm.

Droplet size was measured herein using samples of the mini-emulsion diluted with deionized water (or preferably with deionized water saturated with the monomer(s) present in the mini-emulsion). Average droplet diameter of the sample was determined directly within 15 minutes using dynamic light scattering, for example on a Coulter™ N4 Plus or a Nicomp 380 ZLS device.

In step (d) of the present invention the pre-emulsion mixture is mixed applying suitable means such as high stress to produce nano-size droplets. Stress is described as force per unit area. One manner in which stress is exerted is by shear. Shear means that the force is such that one layer or plane moves parallel to an adjacent one. Stress can also be exerted from all sides as a bulk, compression stress, such that stress is exerted without almost any shear. Another manner of exerting stress is by cavitation, which occurs when the pressure within a liquid is sufficiently lowered to cause vaporization. The formation and collapse of the vapor bubbles occurs violently over a short time period and produces intense stress. Another manner of applying stress is the use of ultrasonic energy. It is preferred to use equipment capable of producing localized high shear, preferably along with moderate bulk mixing. Preferably in step (d) the mini-emulsion is obtained by using ultrasound treatment, colloid mill and/or homogenizer. Commercially available instruments that may be used to generate mini-emulsions (e.g. some of which may apply a high shear field) include sonifiers, micro-fluidizers, Manton-Gaulin homogenizers, static mixers and/or rotastators). Given enough energy input a conventional macro-emulsion (such as the pre-emulsion formed from step (c) described herein) may be converted to a mini-emulsion comprising mainly submicron droplets.

The monomer mini-emulsions may be usefully formed at any temperature between the freezing point and the boiling point of the mixture and the components present therein, preferably from about 5° to about 50° C., and more preferably from about 5° to about 20° C.

Step (d) of the process of the invention produces a essentially stable mini-emulsion comprising an aqueous continuous phase and a dispersed phase of droplets which comprise α,β-ethylenically unsaturated monomer(s) and optionally a hydrophobic stabilizer.

Essentially stable denotes a mini-emulsion with a shelf life sufficiently long so the monomer(s) dispersed within the emulsion can be polymerized within the droplets before the mini-emulsion destabilizes and the phases have had time to separate. Mini-emulsions obtained by the process of the invention generally have a shelf life of more than 24 hrs, often more than several days.

Step (e) Polymerizing the Mini-Emulsion

It is preferred that polymerization of the polymer precursors (such as α,β-ethylenically unsaturated monomer(s)) occurs within the droplets within the mini-emulsion.

The polymerization can be initiated by any suitable conventional method known to those skilled in the art, such as by application of heat and/or radiation. Suitable radiation may be actinic radiation and/or ultraviolet (UV) light, (optionally in the presence of another ingredient such as a photo-initiator) and/or ionizing radiation (such as electron-beam), though polymerization by heat is preferred. The method of initiation will be dependent on the polymerization initiator used and will be readily apparent to those skilled in the art.

The polymer precursor(s) are generally polymerized under free radical polymerization conditions, preferably in the presence of a free radical initiator. The polymerization initiator may be either a water-soluble or an oil soluble compound.

The α,β-ethylenically unsaturated polymer precursors used herein may be polymerized in the presence of any suitable (preferably thermal) initiator (such as described herein). They are also preferably polymerized in the presence of the functional polyurethane polymer described herein (such as aliphatic and/or aromatic polyurethanes).

Suitable free radical initiators are well known in the art and comprise (as a non limiting list) for example, organic peroxides such as benzoyl peroxide, lauroyl peroxide, 2,5-dimethyl 2,5-di(2-ethylhexanoylperoxy) hexane and dicumyl peroxide; water soluble (e.g. inorganic) persulfates such as potassium, sodium and/or ammonium persulfate; azo initiators such as azobis-(isobutyro nitrile) (AIBN); azobis (1-cyclohexanecarbonitrile); and/or 4,4′-azobis4-cyano-pentanoic acid (available commercially under the trade designation V-501 from Wako Chemicals); water soluble peroxides (e.g. hydrogen peroxide, and tert-butyl hydroperoxide), bisulfites, metabisulfites, ascorbic acid, sodium formaldehyde sulfoxylate, ferrous sulfate, ferrous ammonium sulfate, ferric ethylenediamine-tetraacetic acid, and the like optionally paired with a suitable reducing agent, for example redox pairs such as those comprising Fe²⁺/H₂O₂, ROH/Ce⁴⁺ (where R is an organic group such as C₁₋₆alkyl or C₅₋₆aryl) and/or K₂S₂O₈/Fe²⁺; tert. butyl hydroxy peroxide (abbreviated as ‘t-BHP’ and available commercially under the trade names ‘Luperox H70’ from Arkema or ‘Trigonox A-W70’ from AkzoNobel), sodium hydroxymethane sulfinate (available commercially under the trade name ‘Rongalit C®’ from BASF); sodium formaldehyde sulfoxylate (available commercially under the trade name ‘Bruggolite FF-6’ from Brueggeman Chemical); and/or any pair with for example ascorbic acid and/or one or more bisulfites.

The typical concentration of initiators is about 0.01 wt. % to about 1 wt. %, preferably about 0.01 wt. % to about 0.5 wt. %, of the total weight of monomers.

Polymerization initiator can be added to the polymerization reaction in any conventional manner known in the art, for example, before and/or during the polymerization step. Depending on the solubility of the initiator it may be added to the aqueous first mixture (e.g. in step (a)) and/or the polymer precursor second mixture (e.g. in step (b)). If the initiator is more soluble in the (optionally hydrophobic) polymer precursor mixture the initiator is preferably added to the polymer precursor second mixture. However if the initiator is more soluble in the aqueous first mixture, it is preferred to add the after the pre-emulsion mixture has been formed initiator (e.g. at the end of step (c)) or more preferably to the mini-emulsion obtained at the end of step (d). It is optionally preferred to add a portion of water-soluble initiator to the aqueous first mixture in step (a) with an effective amount of the optionally water-soluble or water-dispersible stabilizer. The remainder of the initiator can be added continuously or incrementally during the mini-emulsion polymerization. It is currently preferred to continuously add the remaining initiator.

During the polymerization step (e) of the invention, to keep the stabilizing polymer in an amphiphilic state it may be necessary to add further pH adjusting compound as described previously, especially where pH drops during polymerization. Such a drop in pH may be caused by the dissociation of persulfate initiators (for example ammonium persulfate) and/or as any pH adjusting compound already present in the mixture evaporates (for example when ammonia is used). The pH-adjusting compound(s) added during step (e) may be the same or different to any added during any previous step.

Following polymerization, the pH of the latex emulsion may also be adjusted by contacting the latex emulsion with a suitable base in an amount necessary to raise the pH to about 5.5 to about 9, more preferably from about 6.5 to about 8 most preferably about 7 to about 8. Examples of suitable bases for adjusting the pH of the latex emulsion include alkali metal hydroxides, alkaline earth metal hydroxides, ammonium hydroxide, amines, and the like, and mixtures thereof. The currently preferred base for use in the invention is ammonium hydroxide.

Polymerization can be conducted in any conventional reaction vessel capable of an emulsion polymerization and may be carried out over a broad temperature range depending on the choice of initiator. Polymerization can be conducted at a temperature typical for emulsion polymerizations, preferably in a range from about 20° C. to about 95° C., more preferably from about 25° C. to about 85° C., most preferably from about 50° C. to about 80° C., for example from about 60° C. to about 80° C., e.g. about 70° C.

The polymerization time is that time needed to achieve the desired conversion based on the other reaction conditions, e.g. temperature profile, and reaction components, e.g. monomers, initiator, etc. The polymerization time will be readily apparent to those skilled in the art. However optionally the polymerization of the mini-emulsion may be conducted over a period from about 10 min to about 24 hrs, more usually from about 2 to about 10 hours, most usually from about 4 to about 6 hours.

### Polymer Latex

The present invention also relates to an aqueous polymer dispersion (also referred to herein as a polymer emulsion, mini-emulsion and/or polymer latex) obtained and/or obtainable by the processes of the invention as described herein, and to (dry) polymers collectable from such dispersions.

The aqueous polymer dispersion of invention may comprise polymer particles having an average diameter approximately the same as the average size of the droplets in the mini-emulsions from which they were formed.

Preferred polymer lattices of the invention have an average diameter from about 10 to about 900 nanometres (nm), more preferably from about 50 to about 500 nm, most preferably from about 50 to about 400 nm, for example from about 80 to about 350 nm. The particle sizes herein are number average which may be measured by any suitable method such as light scattering.

Preferred aqueous polymer dispersions of the invention have a solids content from about 25% to about 70%, more preferably from about 28% to about 60%, most preferably from about 30% to about 50% by weight of the dispersion.

### GENERAL DEFINITIONS

### Activated Unsaturated Moiety

The term “activated unsaturated moiety”, is used herein (for example for R² in Formula 4) to denote a species comprising at least one unsaturated carbon to carbon double bond in chemical proximity to at least one activating moiety. Preferably the activating moiety comprises any group which activates an ethylenically unsaturated double bond for addition thereon by a suitable electrophilic group. Conveniently the activating moiety comprises oxy, thio, (optionally organo substituted)amino, thiocarbonyl and/or carbonyl groups (the latter two groups optionally substituted by thio, oxy or (optionally organo substituted) amino). More convenient activating moieties are (thio)ether, (thio)ester and/or (thio)amide moiet(ies). Most convenient “activated unsaturated moieties” comprise an “unsaturated ester moiety” which denotes an organo species comprising one or more “hydrocarbylidenyl(thio)carbonyl(thio)oxy” and/or one or more “hydrocarbylidenyl(thio)-carbonyl(organo)amino” groups and/or analogous and/or derived moieties for example moieties comprising (meth)acrylate functionalities and/or derivatives thereof. “Unsaturated ester moieties” may optionally comprise optionally substituted generic α,β-unsaturated acids, esters and/or other derivatives thereof including thio derivatives and analogs thereof.

Preferred activated unsaturated moieties are those represented by a radical of Formula

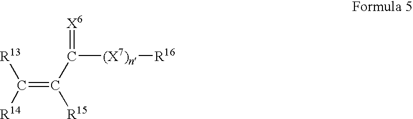

where n′ is 0 or 1, X⁶ is oxy or, thio; X⁷ is oxy, thio or NR¹⁷ (where R¹⁷ represents H optionally substituted organo), R¹³, R¹⁴, R¹⁵ and R¹⁶ each independently represent a bond to another moiety in Formula 1, H, optional substituent and/or optionally substituted organo groups, where optionally any of R¹³, R¹⁴, R¹⁵ and R¹⁶ may be linked to form a ring; where at least one of R¹³, R¹⁴, R¹⁵ and R¹⁶ is a bond; and all suitable isomers thereof, combinations thereof on the same species and/or mixtures thereof.

The terms “activated unsaturated moiety”; “unsaturated ester moiety” and/or Formula 5 herein represents part of a formula herein and as used herein these terms denote a radical moiety which depending where the moiety is located in the formula may be monovalent or multivalent (e.g. divalent). Thus for example in Formula 4 it will be appreciated that at least one of R¹³, R¹⁴, R¹⁵ and R¹⁶ denote a single covalent bond i.e. denote where Formula 5 is attached to the remainder of Formula 4.

More preferred moieties of Formula 5 (including isomers and mixtures thereof) are those where n' is 1; X⁶ is O; X⁷ is O, S or NR⁷.

R¹³, R¹⁴, R¹⁵ and R¹⁶ are independently selected from: a bond, H, optional substituents and optionally substituted C₁₋₁₀hydrocarbo, optionally R¹⁵ and R¹⁶ may be linked to form (together with the moieties to which they are attached) a ring; and where present R¹⁷ is selected from H and optionally substituted C₁₋₁₀hydrocarbo.

Most preferably n′ is 1, X⁶ is O; X⁷ is O or S and R¹³, R¹⁴, R¹⁵ and R¹⁶ are independently a bond, H, hydroxy and/or optionally substituted C₁₋₆hydrocarbyl.

For example n′ is 1, X⁶ and X⁷ are both 0; and R³, R⁴, R⁵ and R⁶ are independently a bond, H, OH, and/or C₁₋₄alkyl; or optionally R⁵ and R⁶ may together form a divalent C₀₋₄alkylenecarbonylC₀₋₄alkylene moiety so Formula 5 represents a cyclic anhydride (e.g. when R¹⁵ and R¹⁶ together are carbonyl then Formula 5 represents a maleic anhydride or derivative thereof).

For moieties of Formula 5 where n′ is 1 and X⁶ and X⁷ are both 0 then when one of (R¹³ and R¹⁴) is H and also R¹³ is H, Formula 5 represents an acrylate moiety, which includes acrylates (when both R¹³ and R¹⁴ are H) and derivatives thereof (when either R¹³ and R¹⁴ is not H). Similarly when one of (R¹³ and R¹⁴) is H and also R¹⁵ is CH₃, Formula 5 represents an methacrylate moiety, which includes methacrylates (when both R¹³ and R¹⁴ are H) and derivatives thereof (when either R¹³ and R¹⁴ is not H). Acrylate and/or methacrylate moieties of Formula 5 are particularly preferred.

Conveniently moieties of Formula 5 are those where n′ is 1; X⁶ and X⁷ are both 0; R¹³ and R¹⁴ are independently a bond, H, CH₃ or OH, and R¹⁵ is H or CH₃; R¹⁶ is H or R¹⁵ and R¹⁶ together are a divalent C═O group.

More conveniently moieties of Formula 5 are those where n' is 1; X⁶ and X⁷ are both O; R¹³ is OH, R⁴ is CH₃, and R¹⁵ is H and R⁶ is a bond and/or tautomer(s) thereof (for example of an acetoacetoxy functional species).

Most convenient unsaturated ester moieties are selected from: —OCO—CH═CH₂; —OCO—C(CH₃)═CH₂; acetoacetoxy, —OCOCH═C(CH₃)(OH) and all suitable tautomer(s) thereof.

It will be appreciated that any suitable moieties represented by Formula 5 could be used in the context of this invention such as other reactive moieties.

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulfamoyl group). Preferred optional substituents comprise: carboxy, sulpho, hydroxy, amino, mercapto, cyano, methyl, halo, trihalomethyl and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen, silicon and/or sulfur, more preferably from hydrogen, nitrogen, oxygen, phosphorus and/or sulfur. Convenient phosphorous containing groups may comprise: phosphinyl (i.e. a ‘—PR₃’ radical where R independently denotes H or hydrocarbyl); phosphinic acid group(s) (i.e. a ‘—P(═O)(OH)₂’ radical); and phosphonic acid group(s) (i.e. a ‘—P(═O)(OH)₃’ radical).

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulfinyl, sulfonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group).

The term ‘hydrocarbo group’ as used herein is a sub-set of a organic group and denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylidene groups comprise divalent groups (which may be represented by “R₂C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC≡”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups); aromatic groups (e.g. in aryl groups) and/or combinations thereof within the same moiety and where indicated may be substituted with other functional groups

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N}organo, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in an organo group is from 1 to 12, especially from 1 to 10 inclusive, for example from 1 to 4 carbon atoms.

Some of the formulae and moieties described herein comprise poly hetero-organo preferably polyoxyhydrocarbylene; more preferably polyoxyalkylene, repeat units that for example can comprise suitable unsubstituted or substituted alkylene groups such as ethylene, propylene, butylene, and isobutylene. It will be appreciated that in this context term multiple repeat units indicates that such moieties described and represented herein may comprise the same and/or different repeat units occurring singly and/or multiple times to represent homo-, block and/or random polymeric moieties and/or any suitable mixtures thereof.

As used herein chemical terms (other than IUAPC names for specifically identified compounds) which comprise features which are given in parentheses—such as (alkyl)acrylate, (meth)acrylate and/or (co)polymer—denote that that part in parentheses is optional as the context dictates, so for example the term (meth)acrylate denotes both methacrylate and acrylate.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers (e.g. E and/or Z forms), diastereoisomers and/or geometric isomers); tautomers (e.g. keto and/or enol forms), conformers, salts, zwitterions, complexes (such as chelates, clathrates, crown compounds, cyptands/cryptades, inclusion compounds, intercalation compounds, interstitial compounds, ligand complexes, organometallic complexes, non-stoichiometric complexes, π-adducts, solvates and/or hydrates); isotopically substituted forms, polymeric configurations [such as homo or copolymers, random, graft and/or block polymers, linear and/or branched polymers (e.g. star and/or side branched), cross-linked and/or networked polymers, polymers obtainable from di and/or tri-valent repeat units, dendrimers, polymers of different tacticity (e.g. isotactic, syndiotactic or atactic polymers)]; polymorphs (such as interstitial forms, crystalline forms and/or amorphous forms), different phases, solid solutions; and/or combinations thereof and/or mixtures thereof where possible. The present invention comprises and/or uses all such forms which are effective as defined herein.

Polymers of the present invention may be prepared by one or more suitable polymer precursor(s) which may be organic and/or inorganic and comprise any suitable (co)monomer(s), (co)polymer(s) [including homopolymer(s)] and mixtures thereof which comprise moieties which are capable of forming a bond with the or each polymer precursor(s) to provide chain extension and/or cross-linking with another of the or each polymer precursor(s) via direct bond(s) as indicated herein.

Polymer precursors of the invention may comprise one or more monomer(s), oligomer(s), polymer(s); mixtures thereof and/or combinations thereof which have suitable polymerizible functionality.

A monomer is a substantially monodisperse compound of a low molecular weight (for example less than one thousand daltons) which is capable of being polymerized.

A polymer is a polydisperse mixture of macromolecules of large molecular weight (for example many thousands of daltons) prepared by a polymerization method, where the macromolecules comprises the multiple repetition of smaller units (which may themselves be monomers, oligomers and/or polymers) and where (unless properties are critically dependent on fine details of the molecular structure) the addition or removal one or a few of the units has a negligible effect on the properties of the macromolecule.

A oligomer is a polydisperse mixture of molecules having an intermediate molecular weight between a monomer and polymer, the molecules comprising a small plurality of monomer units the removal of one or a few of which would significantly vary the properties of the molecule.

Depending on the context the term polymer may or may not encompass oligomer.

The polymer precursor of and/or used in the invention may be prepared by direct synthesis or (if the polymeric precursor is itself polymeric) by polymerization. If a polymerizible polymer is itself used as a polymer precursor of and/or used in the invention it is preferred that such a polymer precursor has a low polydispersity, more preferably is substantially monodisperse, to minimize the side reactions, number of by-products and/or polydispersity in any polymeric material formed from this polymer precursor. The polymer precursor(s) may be substantially un-reactive at normal temperatures and pressures.

Except where indicated herein polymers and/or polymeric polymer precursors of and/or used in the invention can be (co)polymerized by any suitable means of polymerization well known to those skilled in the art. Examples of suitable methods comprise: thermal initiation; chemical initiation by adding suitable agents; catalysis; and/or initiation using an optional initiator followed by irradiation, for example with electromagnetic radiation (photo-chemical initiation) at a suitable wavelength such as UV; and/or with other types of radiation such as electron beams, alpha particles, neutrons and/or other particles. The substituents on the repeating unit of a polymer and/or oligomer may be selected to improve the compatibility of the materials with the polymers and/or resins in which they may be formulated and/or incorporated for the uses described herein. Thus the size and length of the substituents may be selected to optimize the physical entanglement or interlocation with the resin or they may or may not comprise other reactive entities capable of chemically reacting and/or cross-linking with such other resins as appropriate.

Unless the context clearly indicates otherwise, as used herein plural forms of the terms herein are to be construed as including the singular form and vice versa.

The term “comprising” as used herein will be understood to mean that the list following is non-exhaustive and may or may not include any other additional suitable items, for example one or more further feature(s), component(s), ingredient(s) and/or substituent(s) as appropriate.

The terms ‘effective’, ‘acceptable’ ‘active’ and/or ‘suitable’ (for example with reference to any process, use, method, application, preparation, product, material, formulation, compound, monomer, oligomer, polymer precursor, and/or polymers of the present invention and/or described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products.

Many other variations embodiments of the invention will be apparent to those skilled in the art and such variations are contemplated within the broad scope of the present invention.

Further aspects of the present invention are given in the claims.

### EXAMPLES

The present invention will now be described in detail with reference to the following non limiting examples and standard method(s) which are by way of illustration only.

Various registered trademarks, other designations and/or abbreviations are used herein to denote some of ingredients used to prepare polymers and compositions of the invention. These are identified in the table below by chemical name and/or trade-name and optionally their manufacturer or supplier from whom they are available commercially. However where a chemical name and/or supplier of a material described herein is not given it may easily be found, e.g. in ‘McCutcheon's Emulsifiers and Detergents’, Rock Road, Glen Rock, N.J. 07452-1700, USA, 1997 and/or Hawley's Condensed Chemical Dictionary (14th Edition) by Lewis, Richard J., Sr.; John Wiley & Sons.

‘AA’ denotes acrylic acid (CH₂═CHCO₂H).
Abex 2535 is a mixture of aliphatic non ionic surfactants available from Rhodia under this trade designation
AOT-75 is sodium dioctyl sulfosuccinate which is available commercially from Cytec under the trade name Aerosol OT (−75).
‘BHT’ denotes 2,6-di-tert-butyl-4-methylphenol (also known as butyl hydroxy toluene);
‘CEA’ denotes beta carboxy ethyl acrylate (β-CEA) an oligomer formed from AA and which is available commercially from Rhodia under the trade name Sipomer;
‘CN3001’ denotes the mixture of urethane acrylate, monomers, and hydrocarbon resins available commercially from Sartomer under this trade designation.
‘DBTDL’ denotes dibutyl tin dilaurate
‘DM’ denotes dematerialized water
‘EA’ denotes ethyl acrylate.
‘EB230’ denotes the urethane acrylate available commercially from Cytec under the trade mark Ebecryl® 230;
‘EHA’ denotes 2-ethyl hydroxy acrylate
‘EO’ denotes ethoxy (e.g. repeat unit in a polyether moiety).
‘HEA’ denotes hydroxy ethyl acrylate
‘HQ’ denotes hydroquinone;
‘IPDI’ denotes isophorone di-isocyanate;
‘MEHQ’ denotes 4-methoxyphenol (also known as methoxy hydroquinone)
‘Norsocryl 102’ a 75/25 mixture of methyl methacrylate and (2-methacryloxyethyl) heteromonocycle (a ureido monomer) that is available commercially under that trade name from Arkema;
‘PS’ denotes polystyrene such as that available commercially from Hercules under the trade mark Piccolastic® ‘A-75’;
‘SFS’ denotes the sodium formaldehyde sulfoxylate reducing agent available commercially from Rohm & Haas under the trade name Formopon.
‘Soprophor BSU’ denotes a tristyrylphenol ethoxylate (average number of E0 units is ˜16) available commercially from Rhodia under this trade name as a non-ionic surfactant free of alkyl phenol ethoxylate (APE).
‘Soprophor S40’ denotes a tristyrylphenol ethoxylate (average number of E0 units is ˜40) available commercially from Rhodia under this trade name as a non-ionic surfactant free of alkyl phenol ethoxylate (APE).
‘Soprophor 40384’ denotes the aromatic ethoxylated sulfate, ammonium salt with the structure described previously herein and available commercially from Rhodia as a 25% dispersion in water under this trade name;
‘SPS’ denotes sodium persulfate initiator
‘STY’ denotes stryene
‘TBHP’ denotes tert. butyl hydroxy peroxide commercially available for example as 70%
TBHP in 30% water under the trade designations Luperox H70 or Trigonox A-W70 (respectively from Arkema or AkzoNobel); and
‘TMI’ is a trade mark of Cytec for the material di-methyl meta-isopropenyl benzyl isocyanate;
‘XSM5006’, ‘XSM5106’ and ‘XSM5206’ denotes various reactive urethane oligomers available from Cytec under these designations.

The Examples of the invention are prepared by one or more of the common methods described herein below with reference to the information in the tables below. For example the ingredients used to prepare each of the Examples of the invention are shown in the tables.

### Common Polyurethane Synthesis 1 (PU 1)

A monol (‘A¹’, ‘a¹’ g) is added to a one liter reaction vessel which has been purged with dry nitrogen. The vessel contents are then heated to 90° C. and controlling materials were added (e.g. ‘B¹’, ‘b¹’ g) and the resultant mixture agitated with a mixer at a speed of 70 rpm whilst di-functional isocyanate (‘C¹’, ‘c¹’ g) is slowly added to the vessel at a rate that keeps the reaction temperature lower than 100° C. After this addition the isocyanate content of the mixture is measured (as % of NCO groups) every hour until it is less than 0.2% when the temperature of the mixture is decreased to room temperature. The resultant polyurethane is collected (optionally by pouring out of the reaction vessel if a liquid) and was characterized as given in the tables.

### Common Polyurethane Synthesis 2 (PU2)

A di-isocyanate (‘C²’, ‘c²’ g) is added to a one liter reaction vessel which has been purged with dry nitrogen. The vessel is then placed in a water bath to maintain the temperature at 18-20° C. and the contents agitated with a mixer at a speed of 120 rpm. A monol (‘A²’, ‘a²’ g) is added to the vessel drop by drop and the reaction temperature is maintained around 20° C. (but less than 25° C.). After the monol is completely added the reaction is held at 20° C. for a certain period (‘h¹’ minutes), and then the vessel contents heated to 60° C. To prevent a dramatic temperature increase further monol (‘A′’, ‘a′²’ g) is slowly added to the mixture at 60° C. The mixture may be optionally held at 60° C. for a further period (‘h²’ minutes) after which optional further monol (‘A″’ ‘a″²g) may added. The isocyanate content of the mixture is measured (as % of NCO groups) every hour until it is less than 0.2% when the temperature of the mixture is decreased to room temperature. The resultant polyurethane is collected (optionally by pouring out of the reaction vessel as a liquid).

TABLE 1
Polyurethanes (PUs)

| Ex- | | | | | | | |
|---|---|---|---|---|---|---|---|
| am- | Proc- | Monol | | Con. Mat | | PU | |
| ple | ess | ‘A’ | ‘a’/g | ‘B’ | ‘b’/ppm | ‘C’ | ‘c’/g |
| 1 | PU1 | BSU | 277.5 | DBTDL | 75 | TMI | 50.25 |
| | | | | BHT | 500 | | |
| | | | | MEHQ | 100 | | |
| 2 | PU1 | S/40 | 110.0 | DBTDL | 75 | TMI | 10 |
| | | | | BHT | 500 | | |
| | | | | MEHQ | 100 | | |
| 3 | PU2¹ | A = HEA | 13.36 | DBTDL | 139 | IPDI | 50.54 |
| | | (h¹ = 60 mins.) | | BHT | 1742 | | |
| | | A′ = BSU | 205.2 | MEHQ | 348 | | |
| | | A″ = HEA | 18.18 | | | | |
| | | (h² = 60 mins.) | | | | | |

Table 1 footnotes
¹Example 3 uses a 500 mL reaction vessel

TABLE 2
Characterization of PUs from Table 1

| | | | Mₙ/ |
|---|---|---|---|
| Example | Physical properties | Color | gmol⁻¹ |
| 1 | Liquid at room temp. | Dark brown | 1400 |
| 2 | Solid at room temp. | Dark brown | 2940 |
| 3 | Liquid at room temp | Slightly | ¹ |
| | | yellow | |

Table 2 footnotes
¹The final product has multiple peaks in molecular weight distribution, with >50% of the polymer mixture comprising oligomers having a molecular structure where one HEA molecule and one Soprophor BSU molecule are connected to one IPDI molecule.

### Common PSA Preparation

### Step (i) Forming the Mini-Emulsion (ME)

Mini-emulsions are prepared using the following method with reference to Table 3. In one suitable vessel surfactants (‘S’/‘s’ g) are fully dissolved in water to form a mixture referred to herein as the “aqueous phase”. In another suitable vessel polymers (‘P’/‘p’ g) are first dissolved in a mixture of acrylic monomers (‘M’/‘m’ g) to form a mixture referred to herein as the “oil phase”. The aqueous and oil phases are well mixed to form a thick, white pre-emulsion, which comprises droplets of dispersed phase ranging in size generally from 1 to 10 μm or even larger. The pre-emulsion is then subject to high shear (by any of suitable methods as described herein, for example the vessel containing pre-emulsion may be placed in a cold water bath, and sonified for 6 minutes using a Branson, Model 450 sonifier set at an amplitude of 90%) to form a thick white mini-emulsion comprising mainly submicron droplets.

TABLE 3
Step (i) - Mini-emulsion preparation

| Exam- | Aqueous phase | | Oil Phase | | | |
|---|---|---|---|---|---|---|
| ple | ‘S’ | ‘s’/g | ‘M’ | ‘m’/g | ‘P’ | ‘p’/g |
| 4(i) | DM | 271.06 | EHA | 151.32 | PS (A-75) | 18.87 |
| | 4D384 | 6.02 | EA | 23.01 | PU (Ex1) | 9.45 |
| | Abex 2535 | 1.51 | STY | 9.59 | | |
| | AOT-75 | 0.75 | N102 | 3.45 | | |
| | | | AA | 2.30 | | |
| | | | CEA | 1.92 | | |
| 5(i) | As Example 4(i) | | As Example 4(i) | | PS (A-75) | 18.87 |
| | | | | | PU (Ex 3) | 9.45 |
| 6(i) | DM | 269.73 | EHA | 296.70 | PS (A-75) | 36.89 |
| | 4D384 | 11.80 | EA | 45.13 | EB230 | 18.45 |
| | Abex 2535 | 2.95 | STY | 18.80 | | |
| | AOT-75 | 1.48 | N102 | 6.77 | | |
| | | | AA | 4.51 | | |
| | | | CEA | 3.76 | | |

| | | | | |
|---|---|---|---|---|
| 7(i) | As Example 6(i) | As Example 6(i) | PS (A-75) | 3.70 |
| | | | CN3001 | 18.45 |
| 8(i) | As Example 6(i) | As Example 6(i) | PS (A-75) | 3.70 |
| | | | XSM5006¹ | 18.45 |
| 9(i) | As Example 6(i) | As Example 6(i) | PS (A-75) | 3.70 |
| | | | XSM5106² | 18.45 |
| 10(i) | As Example 6(i) | As Example 6(i) | PS (A-75) | 3.70 |
| | | | XSM5206 | 18.45 |
| Comp | As Example (i) | As Example 6(i) | PS (A-75) | 36.89 |
| B(i) | | | | |

Table 3 footnotes
¹XSM5006 took overnight to dissolve in the acrylic monomers.
²XSM5106 is not completely soluble in the acrylic monomers, a turbid dispersion formed

### Preparation of PSA Latex (PSA) (Step (ii)

PSA lattices are prepared using the following method with reference to Table 4. An initial fraction of the mini-emulsion (prepared from step (i), ‘e¹’ g) is added to a two liter jacketed glass reactor containing water (‘w¹’ g) and equipped with a condenser, thermocouple and agitator. The mixture is heated to 82° C. Some first thermal initiator (‘I’ ‘i’ g) dissolved in water (‘w²’ g) is added to the vessel to start the seed polymerization and the reaction mixture is held for minutes or until the exotherm subsides. Then the further (remaining) mini-emulsion from step (i) and initiator (‘I’ ‘i’ g) dissolved in water (w³/g) are both added to the mixture slowly at a respective rates of for the mini-emulsion ‘Rₑ’ g per minute over a delay period of ‘Dₑ’ minutes and for the initiator ‘Rᵢ’ ml per minute (using a syringe pump) over a delay period of ‘Dᵢ’ minutes. During the addition the reaction temperature is maintained at 82-83° C. and when the addition is finished the reaction mixture is held at 82-83° C. for a further ‘h²’ minutes, after which the vessel contents are cooled to 60° C. A redox initiator is added (‘RI/‘ri’ g) the mixture held at the reaction temperature for another 30 minutes and then cooled down to room temperature where the latex is collected by filtration and characterized below.

TABLE 4
Step (ii) - Latex preparation

| | Ex 4 | | | Ex 8 |
|---|---|---|---|---|
| | (ii) & | | | (ii) & |
| | Ex 5 (ii) | Ex 6 (ii) | Ex 7 (ii) | Ex 9 (ii) |
| Water ‘w¹’/g | 100 | 100 | 100 | 100 |
| First mini-emulsion ‘e¹’/ | 100 | 100 | 100 | 95.0 |
| g | | | | |
| First initiator l/‘i’/g | SPS (0.15) | SPS (0.15) | SPS (0.15) | SPS (0.15) |
| First DM ‘w²’/g | 5.0 | 5.0 | 5.0 | 5.0 |
| Held for ‘h¹’ minutes | 15 to 30 | 15 to 30 | 15 to 30 | 15 to 30 |
| Remaining initiator l/ | SPS (0.6) | SPS (1.32) | SPS (1.32) | SPS (1.32) |
| (‘i’ g) | | | | |
| Remaining DM ‘w³’/g | 20.0 | 20.0 | 20.0 | 20.0 |
| Rₑ (g/minutes) | 3.33 | 3.33 | 3.33 | 3.33 |
| Dₑ (minutes) | 120 | 180 | 180 | 180 |
| Rᵢ (ml/minutes) | 0.17 | 0.15 | 0.12 | 0.12 |
| Dᵢ (minutes) | 120 | 180 | 180 | 180 |
| Held for ‘h²’ minutes | 40 | 40 | 40 | 40 |
| RI/‘ri’ g | Note 1 | Note 1 | Note 1 | Note 1 |

Table 4 footnotes
¹Redox initiator system of 0.34 g of TBHP in 5.0 g DM & 0.29 g of SFS in 2.61 g DM.

### Characterization of Lattices

The solid content (as a weight %) of lattices prepared as described herein is determined by placing known amount of latex into a weighed aluminum weighing tin, which is dried at 150° C. for 60 minutes, weighing the tin again and calculating the solids. The average particle size (PS) is as measured as a linear dimension by a Horiba laser light scattering particle size distribution analyzer model Horiba LA-910. The pH of the latex prior to neutralization is measured by an Orion model pH meter. The latex was than neutralized with ammonium hydroxide to a pH given in the table below.

TABLE 5
Latex characterization

| | Ex 4 | Ex 5 | Ex 6 | Ex 7 | Ex 8 | Ex 9 | Ex 10 |
|---|---|---|---|---|---|---|---|
| Solids (%) | 35.02 | 35.47 | 49.75 | 48.7 | 50.40 | 49.37 | ~50 |
| PS (nm) | 170 | 184 | 300 | 368 | 278 | 276 | 224 |
| pH (before neutralization) | 2.20 | 2.40 | 2.20 | 2.0 | 2.30 | 2.30 | 2.20 |
| pH (after neutralization) | 7.10 | 7.30 | 7.04 | 7.0 | 7.14 | 7.05 | 7.10 |

### Testing of PSA Properties

The neutralized latex prepared as described above is coated on a 1 mil Mylar film. The film was air dried for 10 minutes and heat dried at 90 C for 5 minutes. The coated Mylar was laminated with a release liner. The moisture vapor transmission rate (MVTR) of the PSA film is measured in units of g/24 hour/m² according to ASTM D3833/D3833M. The Mylar film coated with the adhesive was applied to a substrate (either stainless steel (SS) or high density polyethylene (HDPE)) and peeled off after 20 min and 24 hours of aging using an Instron machine and the respective peel values are recorded. The shear value of the adhesive film is determined by applying 1 lb weight on a 0.5″×0.5″ strip adhered to a stainless steel (SS) substrate. The time taken (in hours) for the weight to fall is recorded. The data are given in the table below (where NM denotes not measured):

TABLE 6
PSA test data

| | Ex 4 | Ex 5 | Ex 6 | Ex 7 | Ex 8 | Ex 9 | Ex 10 |
|---|---|---|---|---|---|---|---|
| MVTR of PSA film (g/24 hr/m²) | 574 | 597 | NM | NM | NM | NM | NM |
| Peel on SS (after 20 mins) lb/in | 5.59 | 1.46 | 1.18 | 1.95 | 1.82 | 2.22 | 1.21 |
| Peel on SS (after 24 hrs) lb/in | 5.56 | 1.80 | 1.53 | 2.0 | 2.49 | 2.99 | 1.72 |
| Peel on HDPE (after 20 mins) lb/in | 1.26 | 0.52 | 0.41 | 0.41 | 0.36 | 0.72 | 0.24 |
| Peel on HDPE (after 24 hrs.) lb/in | NM | NM | NM | NM | 0.58 | 0.73 | 0.17 |
| Shear on SS (hours) | 0.7 | 11.6 | >700 | 126 | ¹ | ¹ | ¹ |

Table 6 footnotes
¹For Examples 8, 9 & 10, the shear values were measured in two tests: with a one pound weight on a 0.25 in² sample (1 lb test) and for one kilogram weight on a 0.25 in² sample (1 kg test).
The shear results in hours are given in Table 7.

TABLE 7
Shear data

| Test | Ex 8 | Ex 9 | Ex 10 |
|---|---|---|---|
| 1 lb | >1968 | >330 | 567.9 |
| 1 kg | 11.8 | 4.7 | 3.3 |

### Comparative Examples

The following comparative examples were also prepared and/or tested herein. Comp A is a PSA product GME 2484 available commercially from Cytec under this trade designation.

Comp B, D, and E were prepared by a conventional emulsion polymerization having the same composition with Examples 4, 7, and 8, respectively. This means the pre-emulsions were polymerized directly as a macro-emulsion without first being converted to a mini emulsion. Otherwise the same process conditions were used as described above and in the tables herein.

Comps C is a mini-emulsion polymerization of Ex. 6 without the polyurethane component.

The data are given in the table below (where NM denotes not measured):

TABLE 8
comparative data

| | Comp A | Comp B | Comp C | Comp D | Comp E |
|---|---|---|---|---|---|
| Solids (%) | NM | 27.81¹ | 49.72 | 48.0¹ | ² |
| PS (nm) | NM | 283 | 285 | 109 | NM |
| pH (before neutralization) | NM | ~2.0 | 2.10 | 2.64 | NM |
| pH (after neutralization) | NM | 7.10 | 7.00 | 8.19 | NM |
| MVTR of PSA film (g/24 hr/m²) | 535 | NM | 534 | NM | NM |
| Peel on SS (after 20 mins) lb/in | NM | 1.46 | 2.08 | 1.90 | NM |
| Peel on SS (after 24 hours) lb/in | NM | 1.93 | 2.90 | 2.40 | NM |
| Peel on HDPE (after 20 mins) lb/in | 0.70 | NM | 1.03 | 0.46 | NM |
| Shear on SS (hours) | NM | 85.3 | 69.3 | 3.5 | NM |

Table 8 footnotes
¹The process to prepare Comps B & D produced a lot of coagulum.
²Although the process to prepare Comp E produces a stable pre-emulsion, significant coagulum is generated during the pre-emulsion delay process and therefore the reaction was terminated.

The comparative examples demonstrate the advantage of using mini-emulsion compared to conventional emulsion. The conventional emulsion technique gives good adhesion but low shear and formation of heavy coagulum.

1. A multi step process for preparing an aqueous dispersion of heterogeneous polymer particles by mini-emulsion polymerization, the process comprising the steps of
(a) forming an aqueous mixture (first mixture) comprising:
(i) water; and
(ii) at least one stabilizer which is optionally hydrophilic,
(b) forming separately from the first mixture a polymer precursor mixture (second mixture) comprising:
(i) at least one functional polyurethane polymer that comprises at least one activated unsaturated moiety and is substantially free of unreacted isocyanate groups;
(ii) at least one α,β-ethylenically unsaturated polymer precursor; and
(iii) optionally at least one co-stabilizer which is optionally hydrophobic; and
where components (i), (ii) and/or (iii) may optionally be the same;
(c) mixing the first and second mixtures together to form a pre-emulsion;
(d) applying suitable means, optionally a high shear field, to the pre-emulsion from step (c) to form an essentially stable mini-emulsion comprising an aqueous continuous phase and dispersed therein stabilized droplets of average diameter from about 10 nm to about 1000 nm,
(e) polymerizing the polymer precursor(s) optionally in the presence of a free radical initiator; to obtain a latex of a hybrid urethane acrylic polymer.

2. A process according to claim 1, in which the stabilizer comprises a hydrophilic aromatic surfactant and/or a hydrophilic aliphatic surfactant.

3. A process according to claim 2 in which the stablizer comprises at least one arylphenol alkoxylate and at least one alkoxy polyalkylylene glycol.

4. A process according to claim 1, in which the functional polyurethane is obtained and/or obtainable from one or more suitable mono or poly(isocyanates).

5. A process according to claim 4, in which the mono or poly-isocyanate is selected from one or more aromatic and/or aliphatic mono or di-isocyanates.

6. A process according to claim 5, in which the isocyanate is selected from the group consisting of: tetramethylene di-isocyanate, hexamethylene di-isocyanate, dodecamethylene di-isocyanate, 1,4-diisocyanatocyclohexane, 3-isocyanatomethyl-3,3,5-trimethylcyclohexylisocyanate (isophorone di-isocyanate), 4,4′-diisocyanatodicyclohexylmethane, 4,4′-diisocyanato-3,3′-dimethyldicyclohexylmethane, 4,4′-diisocyanatodicyclohexylpropane-(2,2), 1,4-diisocyanatobenzene, 2,4- or 2,6-diisocyanato-toluene and/or mixtures of these isomers, 4,4′-, 2,4′- or 2,2′-diisocyanatodiphenylmethane and/or mixtures of these isomers, 4,4′-diisocyanatodiphenylpropane-(2,2), p-xylylene di-isocyanate and/or α,α,α′,α′-tetramethyl-m- or -p-xylylene di-isocyanate, unsaturated aliphatic isocyanate and/or mixtures of any of these compounds.

7. A process according to claim 1, in which the functional polyurethane used in step (b) is obtained and/or obtainable by a process comprising the step of polymerization in the presence of a suitable catalyst and/or free radical inhibitor of:
(1) an isocyanate functional polymer precursor, optionally obtained and/or obtainable from one or more suitable mono or poly-isocyanates as described in claims 3, 4 and/or 5; together with
(2) at least one compound with a single isocyanate reactive group, optionally selected from a group consisting of carboxy, thiol, hydroxy and amino; and/or
(3) at least one α,β-ethylenically unsaturated polymer precursor;
where components (2) and (3) may optionally be the same;
to obtain a functional polyurethane polymer that optionally comprises at least one activated unsaturated moiety and is substantially free of unreacted isocyanate groups.

8. A process according to claim 1, in which the functional polyurethane used in step (b) is obtained and/or obtainable by a process comprising at least one step selected from:
reacting suitable compounds comprising terminal cyclocarbonate groups with suitable compounds comprising terminal primary amine groups;
reacting suitable carbonated vegetable oils with suitable polyamines; and/or
transesterifying suitable hydroxyalkyl carbamates with suitable (meth)acrylate(s) and suitable carbonates and/or diesters.

9. A process according to claim 7, in which the compound with a single isocyanate reactive group comprises a monol, optionally a suitable mono hydroxy functional α,β-ethylenically unsaturated monomer.

10. A process according to claim 9, in which the monol comprises a (meth)acrylate monomer, optionally hydroxy alkyl(meth)acrylate and/or hydroxyl ethyl acrylate.

11. A process according to claim 1, where the α,β-ethylenically unsaturated monomer comprises: styrenes, acrylates, methacrylates, vinyl and vinylidene halides, dienes, vinyl esters and mixtures thereof.

12. A process according to claim 11, where the α,β-ethylenically unsaturated monomer is selected from the group consisting of 2-ethylhexyl acrylate; styrene; ethyl acrylate; acrylic acid and/or β-CEA

13. A process according to claim 1, where step (d) produces a mini-emulsion comprising stabilized droplets having an average diameter from about 50 nm to about 500 nm.

14. A process according to claim 13, where in step (d) the pre-emulsion is subject to high shear optionally in combination with moderate bulk mixing.

15. A stable aqueous polymer dispersion obtained and/or obtainable indirectly and/or directly by a process as claimed in claim 1.

16. (canceled)

17. A coating; film, adhesive, medical composition for topical application and/or ink composition obtained and/or obtainable using a polymer dispersion as claimed in claim 15.
